(19) United States
(12) Patent Application Publication
(10) Pub. No.: US 2020/0097909 A1
(43) Pub. Date: Mar. 26, 2020

(54) FCV DISPATCH SYSTEM

(71) Applicant: TOYOTA JIDOSHA KABUSHIKI KAISHA, Toyota-shi (JP)

(72) Inventors: Tetsu TODO, Aichi-gun (JP); Koichi IKEMOTO, Nagoya-shi (JP); Motoki HAMAZAKI, Toyota-shi (JP); Katsuhiko HIROSE, Toyota-shi (JP); Atsushi MIZUTANI, Toyota-shi (JP); Shuntaro KATO, Nagoya-shi (JP); Yohei TANIGAWA, Toyota-shi (JP)

(21) Appl. No.: 16/569,990

(22) Filed: Sep. 13, 2019

(30) Foreign Application Priority Data
Sep. 20, 2018 (JP) 2018-175601

(51) Int. Cl. G06Q 10/08; H01M 8/04; G06Q 50/26

(52) U.S. Cl. CPC G06Q 10/08355; H01M 2250/10; G06Q 50/26; H01M 8/04

(57) ABSTRACT

An FCV (fuel cell vehicle) dispatch system comprises a FCV management institution including an FCV management device configured to manage a plurality of FCVs, and a dispatch management system configured to manage dispatch of the plurality of FCVs. The dispatch management system (a) receives available FCV information about at least one FCV that is available for dispatch, from the FCV management device, (b) receives power shortage information indicating occurrence of a power shortage, from a power shortage area where the power shortage has occurred, (c) selects at least one FCV suitable for resolving the power shortage in the power shortage area, based on the available FCV information and the power shortage information, and (d) sends a dispatch request for dispatching the at least one selected FCV to the power shortage area, to the plurality of FCV management device.

### CROSS REFERENCE TO RELATED APPLICATIONS

This application claims priority to Japanese Patent Application No. 2018-175601, filed Sep. 20, 2018, the disclosure of which is incorporated by reference herein in its entirety.

### BACKGROUND

### Field

The present disclosure relates to an FCV (fuel cell vehicle) dispatch system configured to dispatch a fuel cell vehicle.

### Related Art

JP 2018-101592A has disclosed an example of a fuel cell vehicle.

Patent Literature 1: JP 2018-101592A

A power shortage may occur in an area where a disaster such as a flood and an earthquake has occurred. In such a case, technology to resolve the power shortage using a fuel cell vehicle is desired.

### SUMMARY

According to an aspect of the present disclosure, an FCV dispatch system configured to dispatch at least one fuel cell vehicle is provided. This FCV dispatch system comprises a FCV management institution including an FCV management device configured to manage a plurality of FCVs, and a dispatch management system configured to manage dispatch of the plurality of FCVs. The dispatch management system (a) receives available FCV information about at least one FCV that is available for dispatch, from the FCV management device, (b) receives power shortage information indicating occurrence of a power shortage, from a power shortage area where the power shortage has occurred, (c) selects at least one FCV suitable for resolving the power shortage in the power shortage area, based on the available FCV information and the power shortage information, and (d) sends a dispatch request for dispatching the at least one selected FCV to the power shortage area, to the FCV management device.

### BRIEF DESCRIPTION OF THE DRAWINGS

FIG. 1 is an explanatory diagram illustrating a configuration of an FCV dispatch system according to an embodiment;

FIG. 2 is an explanatory diagram illustrating a configuration of an FCV station;

FIG. 3 is an explanatory diagram illustrating a configuration of a large fuel cell vehicle;

FIG. 4 is an explanatory diagram illustrating an FCV management database;

FIG. 5 is a flowchart illustrating procedures of an FCV dispatch process;

FIG. 6 is an explanatory diagram illustrating a dispatch management database;

FIG. 7 is an explanatory diagram illustrating an example of a window showing power shortage information; and

FIG. 8 is a flowchart illustrating procedures of an FCV disposition proposal process.

### DETAILED DESCRIPTION

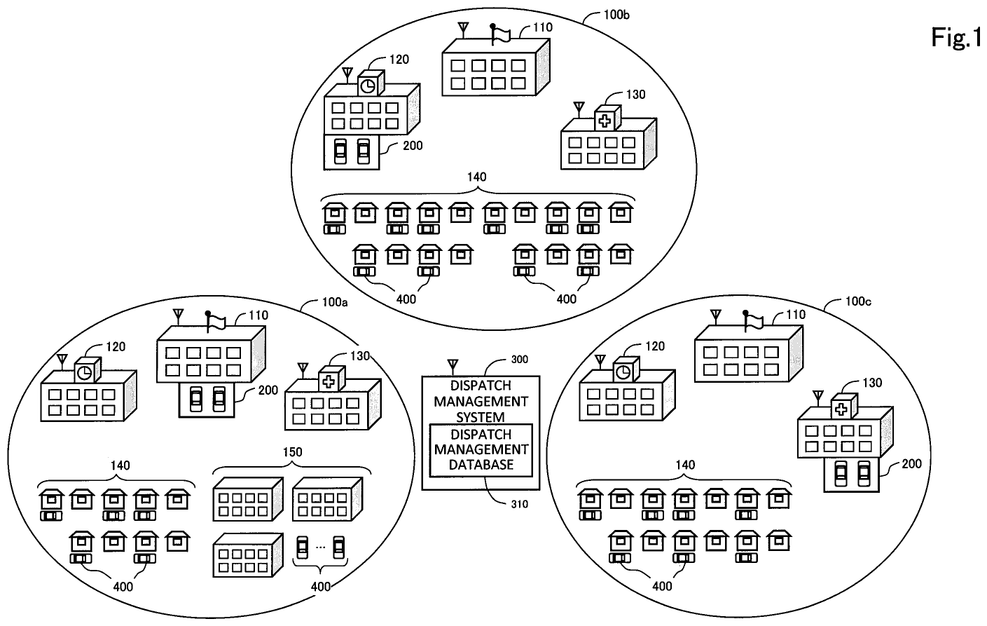

FIG. 1 is an explanatory diagram illustrating a configuration of an FCV dispatch system according to one embodiment. The FCV dispatch system includes a plurality of areas 100a to 100c and a dispatch management system 300. Alphabets “a” to “c” added to the reference numerals of these three areas 100a to 100c are for distinguishing these three areas 100a to 100c. Each of these three areas is simply referred to as an “area 100” if it is not necessary to distinguish them. Each area 100 preferably corresponds to an area administrated by an administrative unit such as a municipality, a state and a country. The dispatch management system 300 is shown outside the three areas 100a to 100c; however, it may be disposed in any one of these areas.

A first area 100a includes a government office 110, a school 120, a hospital 130, a plurality of houses 140, and a plurality of apartments 150. At least some of the plurality of houses 140 have fuel cell vehicles 400.

Similarly to the first area 100a, a second area 100b and a third area 100c each include a government office 110, a school 120, a hospital 130, and a plurality of houses 140. Although the second area 100b and the third area 100c do not include any apartments 150, the second area 100b and the third area 100c may include apartments 150.

In the first area 100a, an FCV station 200 where a plurality of fuel cell vehicles 400 for emergency use are disposed is provided at the government office 110. In the second area 100b, an FCV station 200 is disposed at the school 120, and in the third area 100c, an FCV station 200 is disposed at the hospital 130. As these examples show, the FCV station 200 is preferably disposed at a public facility or a public institution such as the government office 110, the school 120, and the hospital 130. Note that an institution that manages the plurality of fuel cell vehicles 400 at the FCV station 200 in each area 100 is referred to as an “FCV management institution”. Regardless of which institution the FCV station 200 is disposed at, the government office 110 in the area may be designated as the FCV management institution.

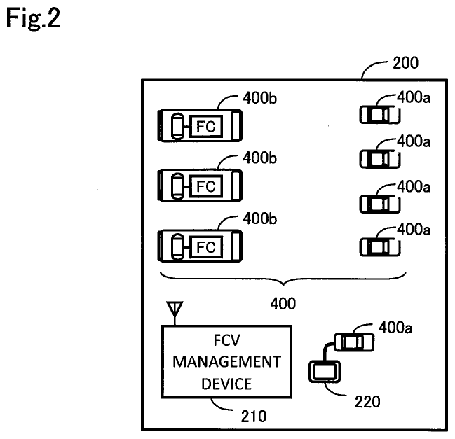

FIG. 2 is an explanatory diagram illustrating a configuration of the FCV station 200. The FCV station 200 includes a plurality of fuel cell vehicles 400, an FCV management device 210 configured to manage the plurality of fuel cell vehicles 400, and a hydrogen dispenser 220. The FCV management device 210 is under the control of the FCV management institution. The hydrogen dispenser 220 may be omitted. However, there is an advantage that if the hydrogen dispenser 220 is disposed at the FCV station 200, hydrogen can be immediately supplied to hydrogen tanks of the plurality of fuel cell vehicles 400 as needed. The plurality of fuel cell vehicles 400 include small fuel cell vehicles 400a and large fuel cell vehicles 400b. The large fuel cell vehicles 400b include fuel cell buses, for example.

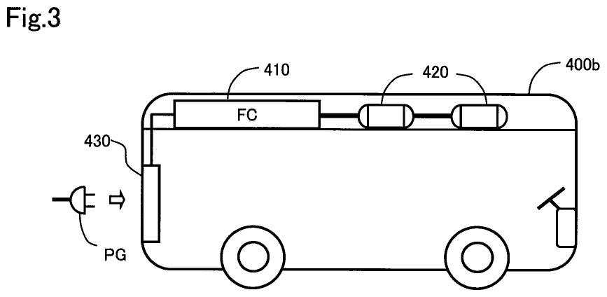

FIG. 3 is an explanatory diagram illustrating a configuration of a large fuel cell vehicle 400b. This fuel cell vehicle 400b includes a fuel cell system 410, a hydrogen tank 420, and an external power feeding device 430. The fuel cell system 410 generates electric power using hydrogen supplied from the hydrogen tank 420. Note that equipment such as a pump and piping required for the power generation is not shown in the figure. The fuel cell system 410 is also simply referred to as a “fuel cell 410”. The external power feeding device 430 includes a socket in which an external plug PG is inserted so that electric power generated by the fuel cell system 410 can be supplied outside. Each of the small fuel cell vehicles 400a shown in FIG. 2 includes a similar external power feeding device 430. The large fuel cell vehicle 400b has a larger capacity of the hydrogen tank 420 and a larger output from the fuel cell system 410, which results in higher utility value as a power source at the time of a disaster, compared with the small fuel cell vehicle 400a. In consideration of this point, the FCV station 200 may include only the large fuel cell vehicles 400b. In the following description, the small fuel cell vehicle 400a is referred to as a “type A”, and the large fuel cell vehicle 400b is referred to as a “type B”. Note that the small fuel cell vehicle 400a and the large fuel cell vehicle 400b are each simply referred to as a “fuel cell vehicle 400” if it is not necessary to distinguish them.

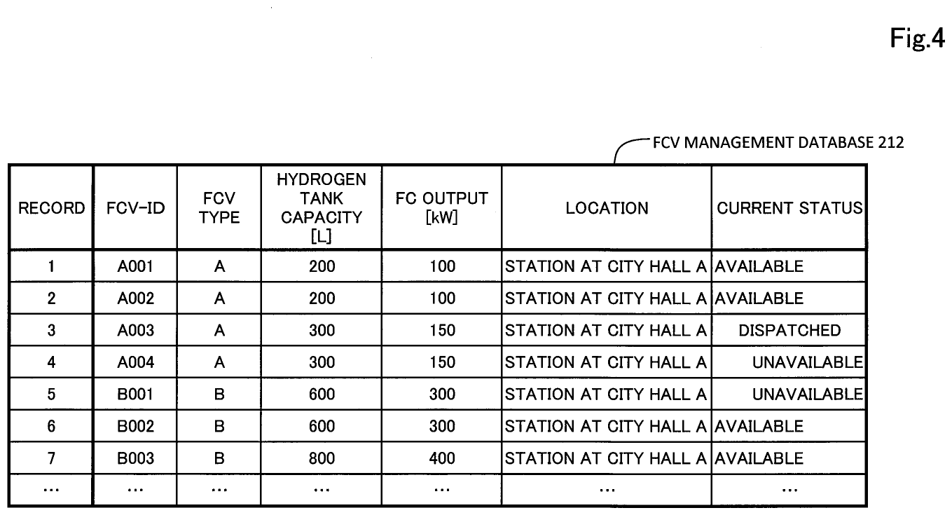

FIG. 4 is an explanatory diagram illustrating an FCV management database 212 managed by the FCV management device 210. In this example, each record in the FCV management database 212 includes the following items:

(1) FCV-ID

“FCV-ID” shows an identification (W) to identify a fuel cell vehicle 400.

(2) FCV type

“FCV type” shows a type of a fuel cell vehicle 400, either A or B, as described with reference to FIGS. 2 and 3. The FCV type may include three types or more. If all the fuel cell vehicles 400 disposed at the FCV station 200 are of the same type, registration of the “FCV type” is not necessary.

(3) Hydrogen tank capacity “Hydrogen tank capacity” shows capacity of a hydrogen tank 420 mounted on a fuel cell vehicle 400.

(4) FC output

“FC output” shows a rated electric power output from a fuel cell system 410 mounted on a fuel cell vehicle 400.

(5) Location

“Location” shows where a fuel cell vehicle 400 is and where it is disposed.

(6) Current status

“Current status” shows whether a fuel cell vehicle 400 is “available”, “dispatched”, or “unavailable” at the moment. “Available” means that a fuel cell vehicle 400 can be dispatched to another area. “Dispatched” means that a fuel cell vehicle 400 has been dispatched to another area. “Unavailable” means that a fuel cell vehicle 400 cannot be dispatched for some reason other than having been “dispatched” to another area. For example, if a fuel cell vehicle 400 is under repair, it is “unavailable”.

The FCV management device 210 appropriately updates registered information in the FCV management database 212. This update may be performed at predetermined intervals or when there is a change in the registered information, for example. Fuel cell vehicles 400 registered with the FCV management database 212 are not limited to the plurality of fuel cell vehicles 400 disposed at the FCV station 200, but may include fuel cell vehicles 400 owned by people living in the area 100. In such a case, it is preferable to have obtained previous permissions from owners of the fuel cell vehicles 400 to use the fuel cell vehicles 400 for disaster control measures.

Meanwhile, it is not necessary to provide the FCV station 200 in each area 100. The FCV management device 210 may manage a plurality of fuel cell vehicles 400 owned by public institutions, companies, and residents in each area 100. In such a case, the FCV management device 210 is preferably disposed at a public institution in the area 100.

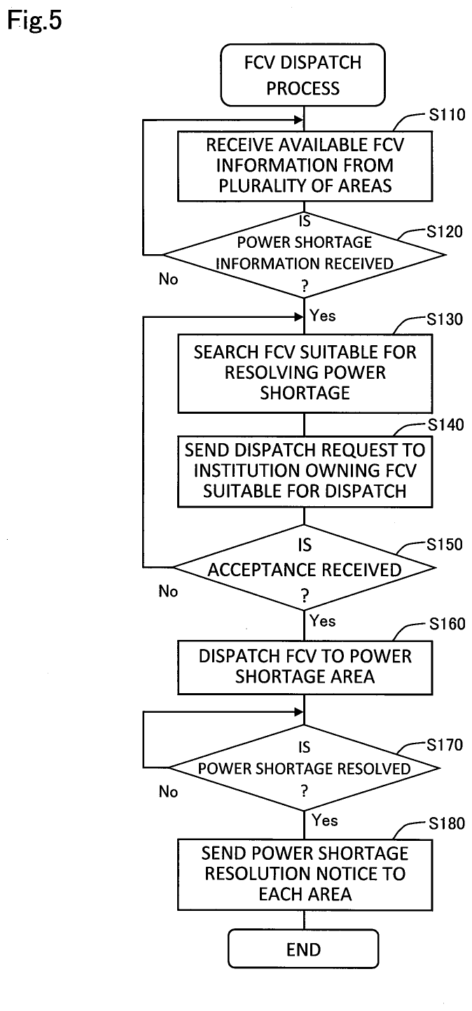

FIG. 5 is a flowchart illustrating procedures of an FCV dispatch process performed by the dispatch management system 300. In a step S110, available FCV information is received from the plurality of areas 100. The available FCV information includes the registered information on the fuel cell vehicles 400 whose “current status” is “available” in the FCV management database 212 shown in FIG. 4. In the example shown in FIG. 4, the registered information on the four fuel cell vehicles 400 with FCV-ID A001, A002, B002 and B003 is sent from the FCV management device 210 in the FCV station 200 to the dispatch management system 300 as the available FCV information. The available FCV information is sent from the FCV management device 210 to the dispatch management system 300 at predetermined intervals for example. Upon receipt of the available FCV information, the dispatch management system 300 updates a dispatch management database 310.

In addition to the information described with reference to FIG. 4, the available FCV information may include at least some of various information described below. For example, with regard to a fuel cell vehicle 400 that is not “available” at the moment, if the time when the fuel cell vehicle 400 becomes “available” can be predicted, the predicted time may be included in the available FCV information. Moreover, a power generation amount per unit hydrogen amount of each fuel cell vehicle 400 may be included in the available FCV information. Furthermore, a hydrogen amount calculated by preliminarily deducting a hydrogen amount necessary for a fuel cell vehicle 400 to make a round trip of a certain distance from a hydrogen tank capacity may be included in the available FCV information as a hydrogen amount available for power generation.

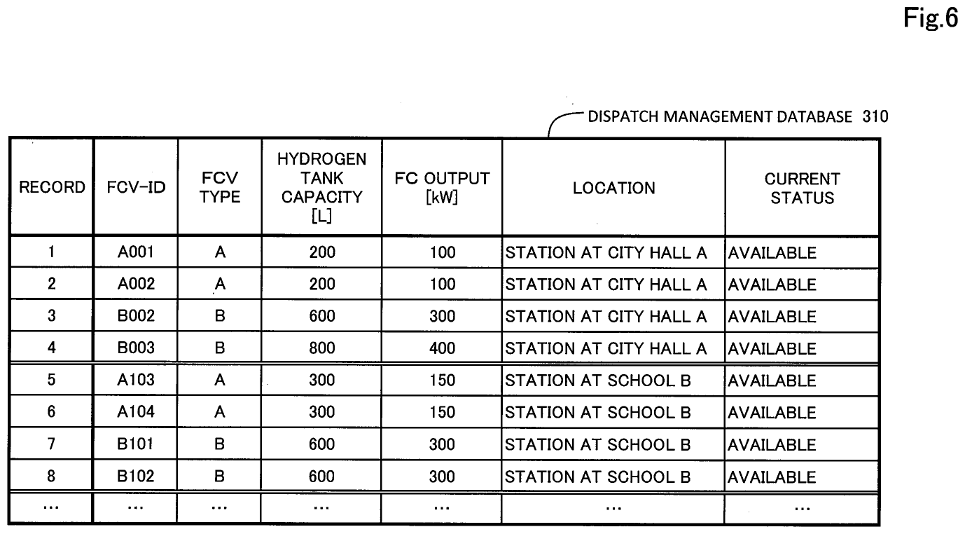

FIG. 6 is an explanatory diagram illustrating the dispatch management database 310. The dispatch management database 310 is a database registering the available FCV information received from each area 100. Registered information in the dispatch management database 310 is almost the same as the registered information in the FCV management database 212 in each area 100 shown in FIG. 4.

In a step S120 in FIG. 5, the dispatch management system 300 determines whether power shortage information has been received from any of the areas 100. For example, if a power shortage occurs in a certain area 100 at the time of a disaster, the power shortage information is sent from a regional management institution of that area 100 to the dispatch management system 300. The “regional management institution” is an institution that administrates the area 100 and is usually the government office 110.

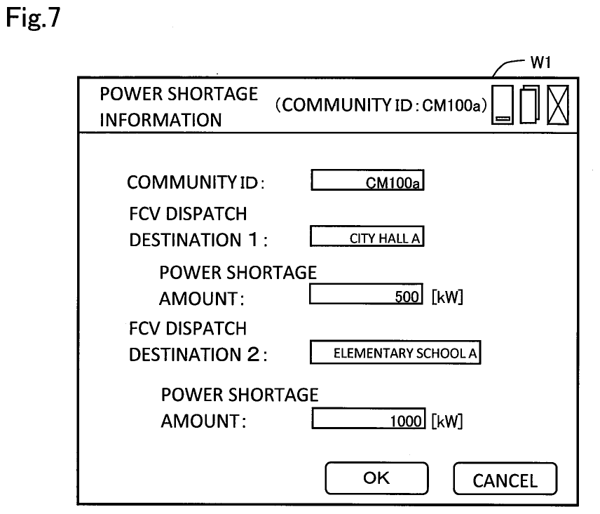

FIG. 7 is an explanatory diagram illustrating an example of a window W1 showing the power shortage information. In this example, the power shortage information includes a community ID, an FCV dispatch destination, and a power shortage amount. The “community ID” is an identifier to specify the area 100 where the power shortage has occurred. The “FCV dispatch destination” shows a specific place where at least one fuel cell vehicle 400 is desired to be dispatched in the area 100, and a plurality of destinations can be specified. The “power shortage amount” shows a power shortage amount at each FCV dispatch destination. This window W1 can be displayed on a screen of a computer owned by the government office 110 or the like that is the regional management institution of the area 100 where the power shortage has occurred so as to set the power shortage information. Once an operator finishes setting the power shortage information and presses an “OK” button, the power shortage information is sent to the dispatch management system 300.

In addition to the information shown in FIG. 7, the power shortage information may include at least some of various information described below. For example, if a power shortage in the near future can be predicted, predicted time of occurrence of the power shortage may be included in the power shortage information. Setting and sending the power shortage information may be performed by an individual; however, it is preferable that a public institution or the like having special authority perform setting and sending the power shortage information because it affects power supply and demand in the area 100.

In the step S120, if the dispatch management system 300 has not received any power shortage information, the process returns to the aforementioned step S110, and if the dispatch management system 300 has received the power shortage information, the process proceeds to the next step S130.

In the step S130, the dispatch management system 300 searches at least one fuel cell vehicle 400 that is suitable for resolving the power shortage in the area 100 where the power shortage has occurred, using power shortage information. This search is performed using the dispatch management database 310 shown in FIG. 6. In the search, it is preferable to preferentially select at least one fuel cell vehicle 400 at the FCV station 200 closer in distance to the area 100 where the power shortage has occurred. The at least one fuel cell vehicle 400 suitable for resolving the power shortage is selected as a vehicle suitable to be dispatched.

Meanwhile, if the dispatch management system 300 has received the power shortage information from two or more of the plurality of areas 100, the search in the step S130 may be performed based on a predetermined priority condition indicating to which area at least one fuel cell vehicle 400 is dispatched preferentially. For example, the search may use a priority condition that a priority level of an area with a larger amount of power shortage is set higher than a priority level of an area with a smaller amount of power shortage. Alternatively, the search may use a priority condition that a priority level of an area with higher population density is set higher than a priority level of an area with lower population density.

In a step S140, the dispatch management system 300 sends a dispatch request to the FCV management device 210 in the FCV management institution owning the at least one fuel cell vehicle 400 suitable for the dispatch. The dispatch request is a request indicating from which area's FCV management institution the at least one fuel cell vehicle 400 is desired to be dispatched in order to resolve the power shortage specified in the power shortage information shown in FIG. 7. The dispatch request preferably includes the FC output of the at least one fuel cell vehicle 400 desired to be dispatched and the number of fuel cell vehicles 400 desired to be dispatched. Alternatively, the dispatch request may include the FCV-ID of the at least one fuel cell vehicle 400 desired to be dispatched.

In a step S150, the dispatch management system 300 determines whether an acceptance is received from the FCV management institution to which the dispatch request has been sent in the step S140. If the acceptance is not received in a predetermined time period, the process returns to the aforementioned step S130. The dispatch management system 300 selects at least one fuel cell vehicle 400 again to resolve the power shortage, and then sends a new dispatch request in the step S140. On the other hand, if the acceptance is received in the predetermined time period, the process proceeds to a step S160. In the step S160, the dispatch management system 300 instructs the FCV management device 210 in the FCV management institution that has accepted the dispatch request to implement the dispatch. In addition, the dispatch management system 300 registers information about which area the at least one fuel cell vehicle 400 is dispatched to in the “Current status” field in the dispatch management database 310.

In a step S170, the dispatch management system 300 waits until the power shortage is resolved. Resolution of the power shortage is determined by receipt of a notice of resolution of the power shortage from the regional management institution in the area where the at least one fuel cell vehicle 400 has been dispatched or by input of information about resolution of the power shortage by an operator of the dispatch management system 300, for example. If the power shortage is resolved, the dispatch management system 300 sends information about the resolution of the power shortage to each area 100. Note that the steps S170 and S180 may be omitted.

According to the aforementioned FCV dispatch system, since the dispatch request for the at least one fuel cell vehicle 400 suitable for resolving the power shortage is sent to the FCV management institution, the at least one fuel cell vehicle 400 can be dispatched to the place where the power shortage has occurred at the time of a disaster or the like so as to resolve the power shortage.

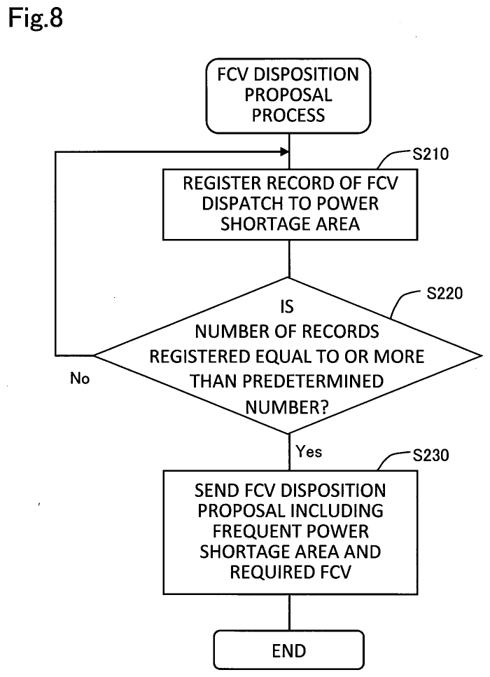

FIG. 8 is a flowchart illustrating procedures of an FCV disposition proposal process performed by the dispatch management system 300. In a step S210, a record of FCV dispatch to a power shortage area is registered with the dispatch management system 300. This registration is performed every time when the process described with reference to FIG. 5 is completed, for example. Alternatively, the step S210 in FIG. 8 may be performed every time when the at least one fuel cell vehicle 400 is dispatched to the power shortage area in the step S160 in FIG. 5.

In a step S220, whether the number of records of the FCV dispatch thus registered is equal to or more than a predetermined number is determined. If the number of records of the FCV dispatch does not reach the predetermined number, the process returns to the step S210 and registration of the records of the FCV dispatch is continued. If the number of records of the FCV dispatch reaches the predetermined number, the process proceeds to a step S230. In the step S230, the dispatch management system 300 makes an FCV disposition proposal including an area where a power shortage occurs frequently and the number of fuel cell vehicles 400 required to resolve a power shortage in that area, based on the registered records of the FCV dispatch, and sends it to the respective FCV management institutions in the plurality of areas 100. As aforementioned, the “FCV management institution” is an institution that manages the plurality of fuel cell vehicles 400 at the FCV station 200 in each area 100. In the example shown in FIG. 1, the FCV management institution is the government office 110 in the area 100a, the school 120 in the area 100b, and the hospital 130 in the area 100c. The FCV management institutions that received the FCV disposition proposal can change the locations of the FCV stations 200 and the fuel cell vehicles 400 so as to facilitate dealing with occurrence of a power shortage according to the proposal.

According to the FCV dispatch system in the aforementioned embodiment, since the dispatch management system 300 sends the FCV disposition proposal, to the respective FCV management institutions, with regard to at least one fuel cell vehicle 400 required to resolve a power shortage in the area where a power shortage occurs frequently, appropriate disposition of the fuel cell vehicles 400 in preparation for a power shortage can be implemented.

The present disclosure is not limited to the embodiments, examples, and modifications described above, and may be implemented by a diversity of other configurations without departing from the scope of the present disclosure. For example, the technical features of any of the above embodiments, examples, and modifications corresponding to the technical features of each of the aspects described in the SUMMARY section may be replaced or combined appropriately, in order to solve part or all of the problems described above or in order to achieve part or all of the advantageous effects described above. Any of the technical features may be omitted appropriately unless the technical feature is described as essential in the description hereof.

(1) According to an aspect of the present disclosure, an FCV dispatch system configured to dispatch at least one fuel cell vehicle is provided. This FCV dispatch system comprises a FCV management institution including an FCV management device configured to manage a plurality of FCVs, and a dispatch management system configured to manage dispatch of the plurality of FCVs. The dispatch management system (a) receives available FCV information about at least one FCV that is available for dispatch, from the FCV management device, (b) receives power shortage information indicating occurrence of a power shortage, from a power shortage area where the power shortage has occurred, (c) selects at least one FCV suitable for resolving the power shortage in the power shortage area, based on the available FCV information and the power shortage information, and (d) sends a dispatch request for dispatching the at least one selected FCV to the power shortage area, to the plurality of FCV management device.

According to the aforementioned FCV dispatch system, since the dispatch request for the at least one FCV suitable for resolving the power shortage is sent to the FCV management institution, the at least one FCV can be dispatched to the place where the power shortage has occurred at the time of a disaster or the like so as to resolve the power shortage.

(2) The dispatch management system according to the aforementioned FCV dispatch system may make an FCV disposition proposal including information about a frequent power shortage area where a power shortage occurs frequently and at least one FCV required to resolve a power shortage in the frequent power shortage area, based on FCV dispatch records, and send the FCV disposition proposal to the FCV management institution.

According to this FCV dispatch system, since the dispatch management system sends the FCV disposition proposal regarding at least one FCV required to resolve a power shortage in the frequent power shortage area, to the FCV management institution, an appropriate FCV disposition in preparation for the power shortage can be implemented.

The present disclosure can be implemented in various aspects, and can be implemented in an FCV dispatch system, a management device or a management method for the FCV dispatch system, for example.

What is claimed is:

1. An FCV dispatch system configured to dispatch at least one fuel cell vehicle (FCV), the system comprising:
a FCV management institution including an FCV management device configured to manage a plurality of FCVs; and
a dispatch management system configured to manage dispatch of the plurality of FCVs,
the dispatch management system being configured to:
(a) receive available FCV information about at least one FCV that is available for dispatch, from the FCV management device;
(b) receive power shortage information indicating occurrence of a power shortage, from a power shortage area where the power shortage has occurred;
(c) select at least one FCV suitable for resolving the power shortage in the power shortage area, based on the available FCV information and the power shortage information; and
(d) send a dispatch request to the FCV management device, the dispatch request requesting to dispatch the at least one selected FCV to the power shortage area.

2. The FCV dispatch system according to claim 1,
wherein the dispatch management system makes an FCV disposition proposal including information about a frequent power shortage area where a power shortage occurs frequently and at least one FCV required to resolve a power shortage in the frequent power shortage area, based on FCV dispatch records, and sends the FCV disposition proposal to the FCV management institution.
